(19) United States
(12) Patent Application Publication
(10) Pub. No.: US 2009/0228774 A1
(43) Pub. Date: Sep. 10, 2009

(54) System for coordinating the presentation of digital content data feeds

(76) Inventors: Joseph Matheny, Santa Barbara, CA (US); Will Phillips, Santa Barbara, CA (US)

Correspondence Address: Charles N.J. Ruggiero;Ohlandt, Greeley, Ruggiero & Perle, L.L.P., 10th Floor, One Landmark Square, Stamford, CT, 06901-2682, US

(21) Appl. No.: 12/074,938

(22) Filed: Mar. 6, 2008

(51) Int. Cl. G06F 17/00; G06F 7/06

(52) U.S. Cl. 715/201; 707/3; 715/277; 707/E17.108

(57) ABSTRACT

A reader for obtaining a plurality of categorized digital content from a content aggregator framework over a communications network based on a content subscription with the aggregator framework, the reader configured for operation on a digital device. The reader includes an interface module configured for receiving content category selections from a user of the device and for identifying a profile of the user including one or more user definitions. A communications module communicates the profile and the content selections to the aggregator framework; and a generation module configured presents updated versions of the digital content to device user when the updated digital content becomes available from the aggregator framework, such that the digital content is assigned to one or more of the content categories as selected by the user. The user definitions of the profile and the content selections of the user are used to determine the contents of the updated digital content obtained by the reader. An aggregator framework is also provided that is configured to communicate with the reader.

### FIELD OF THE INVENTION

This invention relates to presentation of continuously or periodically updated digital content.

### BACKGROUND OF THE INVENTION

Use of the Internet is growing in popularity due to the ever-expanding placement of information that is accessible on-line through various search tools, such as search engines. Placement of media content, and other content such as periodically updated data feeds such as RSS feeds has become increasing popular due to a need to monitor an ever-increasing amount of new information. Further, the Internet is fast becoming the primary information source for obtaining information and news about products, places, people, etc. Unfortunately, the Internet is also quickly becoming a casualty of it's own success due to unmanageable amounts of available data and the inability of users to receive desirable feed content that is of use to the users.

One problem associated with Internet search methodologies is the undesirable volume of feed links results obtained through a seemingly directed search. The amount of information available on any particular topic can be overwhelming to even the most seasoned Internet searcher. Typically, feed search results are filled with voluminous information that may not be appropriate for the search context desired by the searcher. Further, the searcher may desire certain feed types over others. Certainly, it is a disadvantage to the searcher to have to sift through volumes of feed search results that seemingly do not pertain to the interests/desires of the searcher. In addition, current feed readers, as well as feed aggregators, are not appropriately configured to provide a variety of feeds to a user that are desirable with respect to the interests and nature of the user.

### SUMMARY OF THE INVENTION

It is an object of the present invention to provide a digital content presentation system to obviate or mitigate at least some of the above-presented disadvantages.

The Internet is fast becoming the primary information source for obtaining information and news about products, places, people, etc. Unfortunately, the Internet is also quickly becoming a casualty of it's own success due to unmanageable amounts of available data and the inability of users to receive desirable feed content that is of use to the users. Contrary to present systems and methods there is provided a reader for obtaining a plurality of categorized digital content from a content aggregator framework over a communications network based on a content subscription with the aggregator framework, the reader configured for operation on a digital device. The reader includes an interface module configured for receiving content category selections from a user of the device and for identifying a profile of the user including one or more user definitions. A communications module communicates the profile and the content selections to the aggregator framework; and a generation module configured presents updated versions of the digital content to device user when the updated digital content becomes available from the aggregator framework, such that the digital content is assigned to one or more of the content categories as selected by the user. The user definitions of the profile and the content selections of the user are used to determine the contents of the updated digital content obtained by the reader.

One aspect provided is a reader for obtaining a plurality of categorized digital content from a content aggregator framework over a communications network based on a content subscription with the aggregator framework, the reader configured for operation on a digital device, the reader including: an interface module configured for receiving content category selections from a user of the device and for identifying a profile of the user including one or more user definitions; a communications module configured for communicating the profile and the content selections to the aggregator framework; and a generation module configured for presenting updated versions of the digital content to device user when the updated digital content becomes available from the aggregator framework, the digital content being assigned to one or more of the content categories as selected by the user; wherein the user definitions of the profile and the content selections of the user are used to determine the contents of the updated digital content obtained by the reader.

A further aspect provided is a method for obtaining a plurality of categorized digital content from a content aggregator framework over a communications network based on a content subscription with the aggregator framework, the method implemented on a digital device, the method including: receiving content category selections from a user of the device; identifying a profile of the user including one or more user definitions; communicating the profile and the content selections to the aggregator framework; and presenting updated versions of the digital content to device user when the updated digital content becomes available from the aggregator framework, the digital content being assigned to one or more of the content categories as selected by the user; wherein the user definitions of the profile and the content selections of the user are used to determine the contents of the updated digital content obtained.

A further aspect provided is an aggregator framework for obtaining a plurality of digital content from a plurality of content sources over a communications network and for communicating the digital content to a networked reader based on a content subscription with the aggregator framework, the framework comprising; a categorizer module configured for assigning at least one content category to each content of the plurality of digital content, the content category selected from a list of predefined categories; a registration module configured for receiving a content selection from the reader for use in selecting updated digital content from the plurality of digital content based on at least one content category included in the content selection; a generator module for selecting the updated digital content based on the content selection; and a distributor module configured for communicating the updated digital content to the reader over the network.

A further aspect provided is a method for obtaining a plurality of digital content from a plurality of content sources over a communications network and for communicating the digital content to a networked reader based on a content subscription with the aggregator framework, the method comprising; assigning at least one content category to each content of the plurality of digital content, the content category selected from a list of predefined categories; receiving a content selection from the reader for use in selecting updated digital content from the plurality of digital content based on at least one content category included in the content selection; selecting the updated digital content based on the content selection; and communicating the updated digital content to the reader over the network.

### BRIEF DESCRIPTION OF THE DRAWINGS

Exemplary embodiments of the invention will now be described in conjunction with the following drawings, by way of example only, in which:

FIG. 1 is a block diagram of components of an feed presentation system;

FIG. 2 shows example content as an RSS feed for the reader of FIG. 1;

FIG. 3 shows an example updated content for the system of FIG. 1;

FIG. 4 shows an example presentation of the reader of the system of FIG. 1;

FIG. 5 shows a further example presentation of the system of FIG. 1;

FIG. 6 is a block diagram of a reader framework of the system of FIG. 1;

FIG. 7 shows example profile configurations for contents and users of the system of FIG. 1;

FIG. 8 is a block diagram of an aggregation framework of the system of FIG. 1;

FIG. 9 is a block diagram of an example computing device for implementing the components of the system of FIG. 1; and

FIG. 10 shows a further example presentation of the system of FIG. 1.

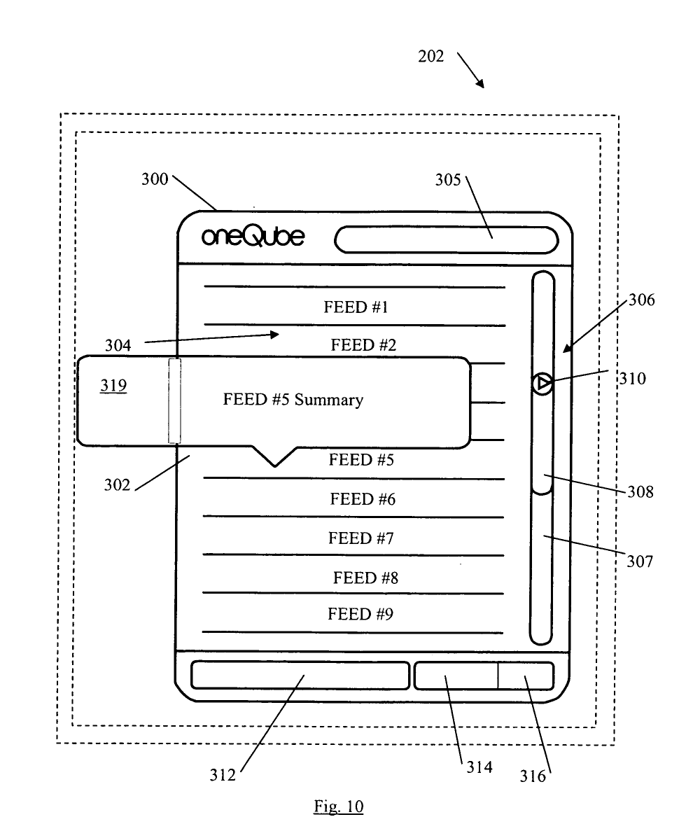

### DETAILED DESCRIPTION OF THE PREFERRED EMBODIMENT(S)

### Content Access System 10

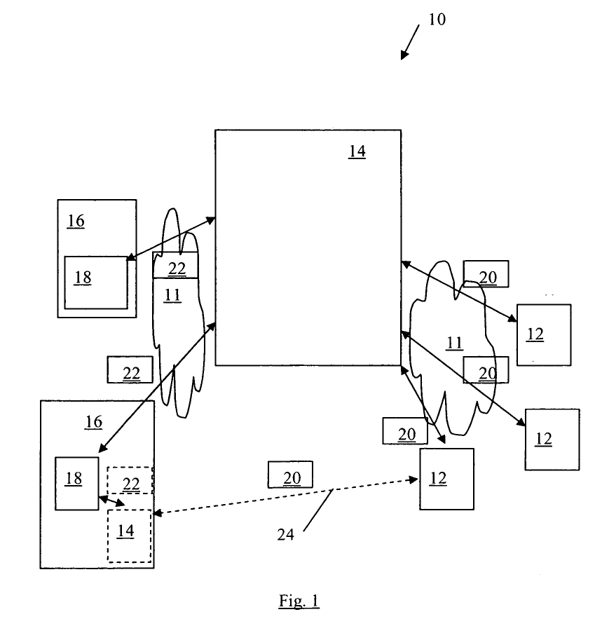

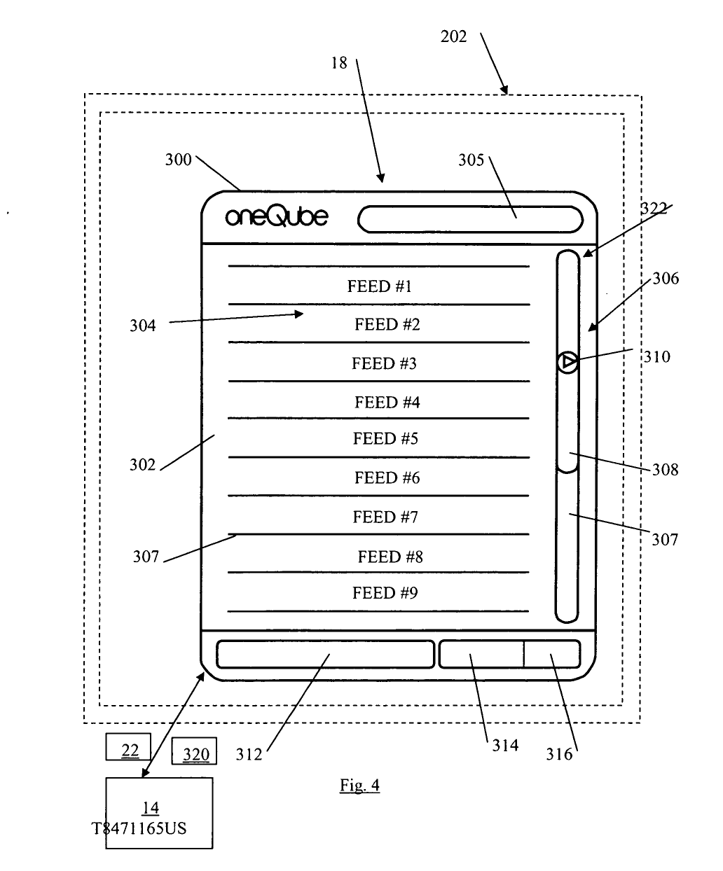

Referring to FIG. 1, shown is an updated content access system 10 for providing a plurality of users 16 (e.g. members of an aggregator framework 14) with frequently updated data content 22 (e.g. a web feed). The content distributor or aggregator framework 14 collects a plurality of individual data content 20 (e.g. syndicated web feeds) from a plurality of content sources 12 and makes the data content 20 available to the users 16 via subscription to the framework 14, as the updated data content 22. The users 16 each have a reader 18 that is coupled over a communications network 11 (e.g. an extranet such as the Internet and/or an intranet) to the framework 14, in order to receive the data content 22 updated every time updating takes place. The feed readers 18 are configured so as to combine selected contents of multiple web feeds 20 for display as a single screen/presentation 300 or series of screens/presentations 300 (see FIG. 4), providing for the users 16 to keep up with their favorite content 20 in an automated manner that can be easier than checking each of the contents 20 manually.

It is recognised that the communication of the updated data content 22 between the reader 18 and the framework 14 can be done on a synchronous and/or asynchronous manner. Further, it is recognised that the individual readers 18 could also be configured to incorporate at least some of the aggregator framework 14 features, thus providing for direct communication 22 with the content sources 12 for the data content 20 that is configured for presentation on the reader 18 as the updated content 22 (shown in ghostview). However, by example only, the following description is provided as indirect communication of the content 20 through a separate framework 14 and reader 18, coupled to one another over the communications network 11.

### Data Content 20,22

### Data Content 20

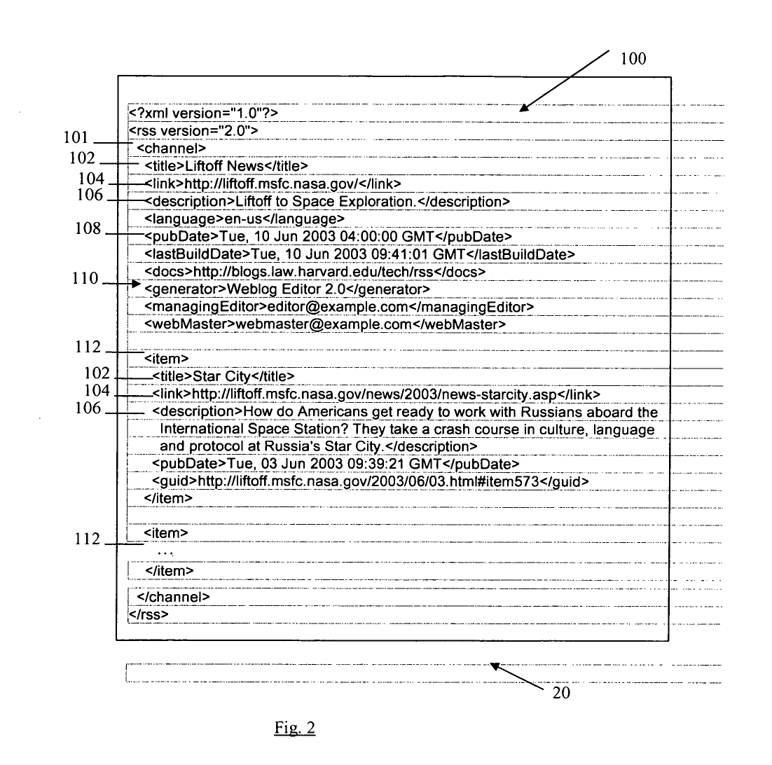

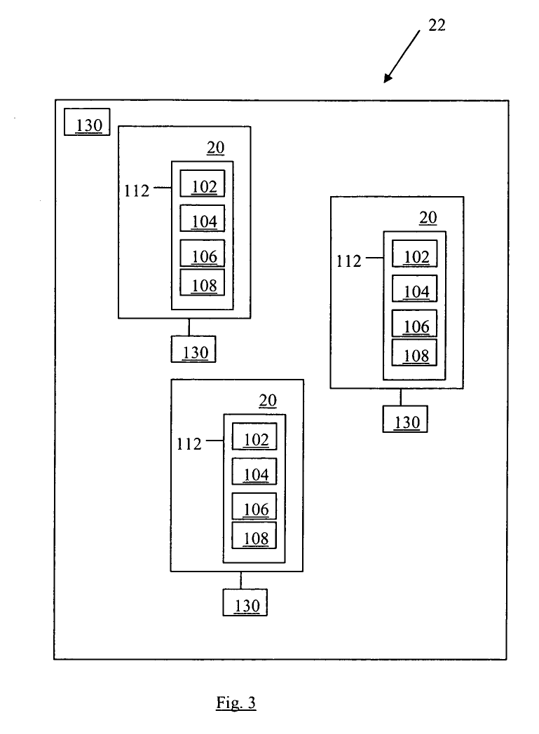

Referring to FIG. 2, the data content 20 (e.g. a web feed) can be a document (often XML-based), which contains content items 112 with web links 104 to longer versions. News websites and blogs can be common sources 12 for web feeds, but feeds are also used to deliver structured information ranging from weather data to “top ten” lists of hit tunes to search results. Two example web feed formats are RSS and Atom. The kinds of content delivered by the data content 20 are typically XML/HTML (content defined in a structured definition language) with links to Web pages (e.g. of the sources 12) and other kinds of digital media. The data content 20 is used as material for inclusion in the updated content 22 (see FIG. 3) as notification to the users 16 of content updates, and may only include summaries in the updated content 22 rather than the full content itself.

The individual data contents 20 can be referred to as a document (e.g. RSS—Really Simple Syndication), called a “feed”, “web feed”, or “channel”, which contains either a summary of content from an associated content source 12 (e.g. web site) and/or the full content (e.g. text). FIG. 2 shows an example of an RSS 2.0 file 20, defined in a structured definition language (e.g. XML) that contains a plurality of content portions 100. For example, the content portions 100 can include portions such as but not limited to: a channel 101 which has a title 102, a link 104 (e.g. URL, IRL) to the content source 12, a corresponding description 106, and (optional) language/publication date 108; followed by a series of one or more items 112, each of which can have the title 102, link 104, and corresponding description 106 (e.g. a summary or the full content or associated content available at the specified link 104. Also, potential portions 100 can include: item-level authors; date; creator's name 110; audio content; video content; and image content. It is recognised that an item's description 106 may contain all of a news article, blog post, etc., or just an extract or summary. The item's link 104 can point to the full content (although it may also point to what the content itself links to).

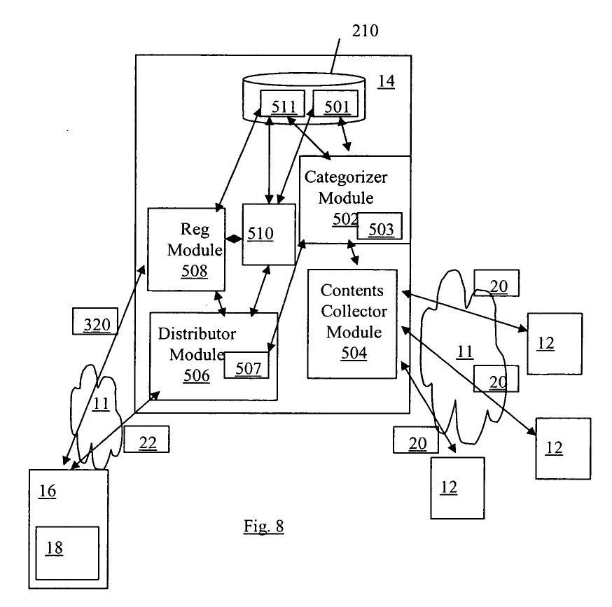

RSS can be referred to as a family of web feed formats used to publish frequently updated digital content 20 (e.g. as material is made available by the framework 14 to the reader 18), thereby providing a mechanism for notifying users 16 of updates to content in a website, blog, or Internet TV channel, for example. Examples of the data contents 20 include any dynamically updatable data content that can be broken down into discrete content for presentation on the reader 18, content such as but not limited to: the “recent changes” page of a wiki; a log; a revision history of a book/document; blogs; news feeds; and podcasts. The data contents 20 can include items 112 (see FIG. 2) in textual, image, video, and/or audio formats, as desired. Once information about each item 112 is in a predefined format (e.g. RSS format), the feed-aware program (e.g. reader 18 and data collector 504 (see FIG. 8) can check or otherwise is to be notified of the selected feed for changes and react to the changes in an appropriate way, as further described below. For example, web sites (e.g. content sources 12) can publish reverse-chronologically ordered content 20, such as blogs and news.

### Updated Data Content 22

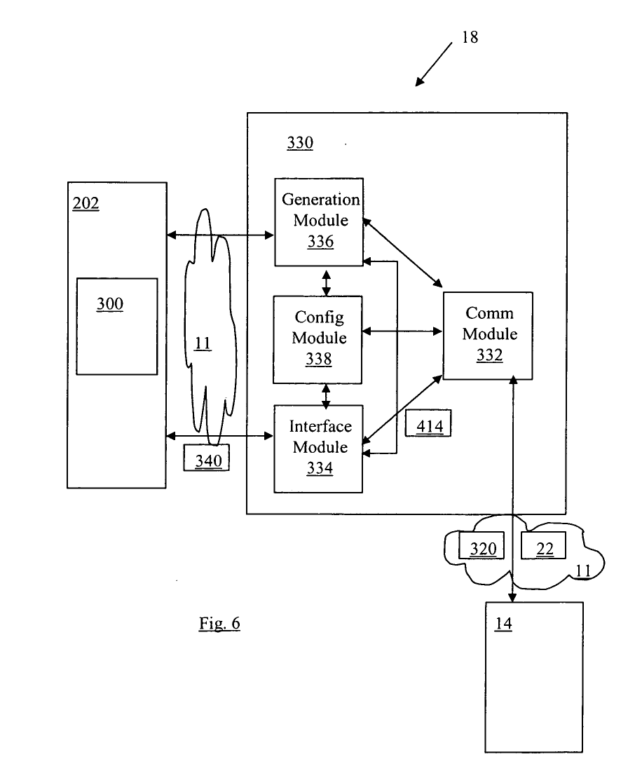

Referring to FIG. 3, the updated content 22 is provided to the reader 18 for display on a user interface 202 (see FIG. 6) of the user 16 device 99. The data contents of the updated content 22 can contain all or a portion of each of the individual data contents 20, referred to by example above, as well as one or more categories 130 that is/are assigned to each of the individual data contents 20 by the framework 14, further described below. The updated content 22 can contain one or more of the individual data contents 20, each labelled by their own assigned category 130, and/or the updated content 22 can be itself assigned its own category 130. Further details on use of the categories 130 is described with reference to the framework 14 and FIG. 8, below.

The updated content 22 is provided to the reader 18 on a periodic/continuous basis (e.g. synchronously and/or asynchronously for example as schedules by the reader 18 and/or the framework 14), either as one update communication containing all of the subscribed/selected content 20 for display by the reader 18, or as a series of communications that in total contain all of the subscribed/selected content 20 for display by the reader 18. As further described below, the reader 18 can interpret and display the updated content 22 based on the associated categories 130. The reader 18 has knowledge of the predefined format of the updated content 22 (e.g. via an XML DTD) and can therefore parse the updated content 22 for selective presentation of the associated data to the user 16.

### Reader 18

### Presentation 300

Referring to FIG. 4, a presentation 300 provides for interaction with the user 16 of the updated content 22 on the user interface 202 (see FIG. 6). The presentation 300 can contain a variety of different media types as available in the updated content 22, namely textual, image, video, and/or audio content. The updated content 22 can include selectable connections (e.g. links 104—see FIG. 2) from one word, picture, or text passage to another. In a multimedia environment such as the Internet, such updated content 22 can include sound and motion video sequences, as well as still pictures and electronic text. One example form of the updated content 22 is a text portion and/or picture/icon (e.g. predefined portion 304) that can be selected by the user 16 (with a mouse or in some other fashion), resulting in the delivery and view of another file obtained from one of the sources 12. The predefined portion 304 can be referred to as an anchor, such that the anchor reference and the object referred to constitute the link. In Hypertext Markup Language (HTML), the anchor is the establishing of a term, phrase, image, or other information object as being either: the target of the hypertext link within a document, or a reference (a link you can select) to such a target. It is recognised that the link mechanisms can include such as but not limited to: Inline Text Links; Text Banners; Graphical/Rich Media Banners; In-page Graphical Banner; Pop-Unders/Ups; XML Feeds; Layer Ads; and Search box, for example. Monitoring of the interaction of the user 16 with certain portions 304 can be used to identify behavioural information 414 of the user 16 (or users 16 associated with access to a particular related content 20) and thus be used to update the private tags 408. The behavioural information 414 can also be supplied to the framework 14 from third party suppliers (e.g. award programs, travel agencies, etc.) who monitor behaviour (e.g. purchase(s), travel, other activities such as hobbies, interests, etc.) of selected users 16 and their interaction with identified content 20 included in the updated content 22.

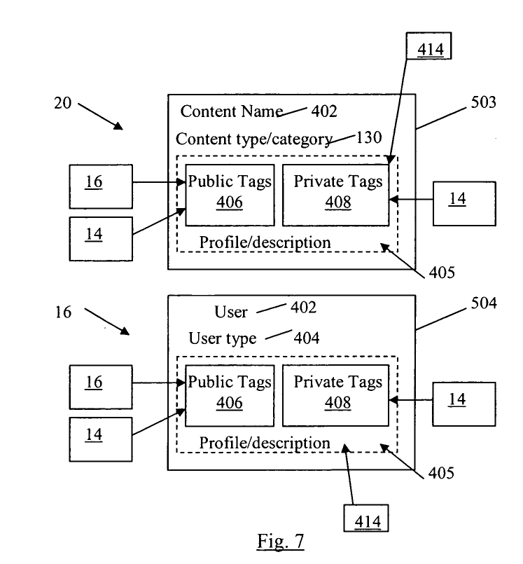

Referring to FIG. 4, the updated content 22 (e.g. RSS) can be read and presented on the user device 16 (i.e. interface 202—see FIG. 6) using software (or combination of software and hardware) called the reader 18. The user 16 subscribes to receive the updated content 22 by registering with the framework 14 and then subsequently entering a respective content link 104 (e.g. the feed's link) into the reader 18 via a manual selection feature 314 (e.g. text entry data field, a drop box with available predefined selections, a browse feature to search for feed selections, etc.) and/or by selecting one or more predefined content category selections 312 (e.g. via a drop down box). The content category selections 312 can be for information related to such as but not limited to: top news; business; entertainment; health; Internet; Life; offbeat; politics; sports; technology; and world. It is also recognised that the category selections 312 can also have sub-category selections 312, sub-sub category selections 312, etc. For example, the category selection 312 “world” could have further sub-category selections 312 of each available world country (e.g. Canada, Europe, Africa, Australia, Congo, etc. Another example is where the category selection 312 “technology” could have further sub-category selections 312 of specific market sectors (e.g. computers, manufacturing, agriculture, etc.). It is recognised that each of the predefined category selections 312 can be combined into a corresponding content selection 320 that is made available to the aggregation framework 14 for assembly of the updated content 22 that is returned to the user 16 for inclusion in the presentation 300 by the reader 18. It is recognised that the content selections 320 can also contain URL/IRL identifications (or other unique identifiers—e.g. name) for specific contents 20 as desired by the user 16. In this case, the aggregation framework 14 may not use categorization/profile matching to select this content 20 from the contents 20 referenced in a content list 501 (see FIG. 7), rather the aggregation framework 14 would use the specific identification for facilitating inclusion of this content 20 in the updated contents 22.

The individual and/or predefined content selections 320 (via reader features 312, 314) are communicated to the framework 14 by the reader 18, so as to register the specific user 16 to receive regular updated content 22 consistent with the user's content selections 320. The reader 18 then checks or otherwise receives the user's subscribed content selections 320 as the updated content 22 regularly for new content, downloading/uploading any updates that the reader 18 and/or framework is made aware of.

Referring again to FIG. 4, the reader 18 provides for rendering of the presentation 300 on the user interface 202 of the user's device 99. The presentation 300 has a content area 302 for displaying the predefined portions 304 that are configured to be populated with one or more content portions 100 of the included content data 20. For example, each of the predefined portions could be configured to display a title 102 for each of the items 112 (see FIG. 2) of each of the individual contents 20 contained in the updated data 22. The reader 18 can be configured so as to only present the predefined portions 304 of the updated contents 22, rather than the entire contents, as a space management mechanism when the reader 18 has been configured to display a number of individual contents 20 (e.g. content selections 320). A border 307 can separate each of the predefined portions 304.

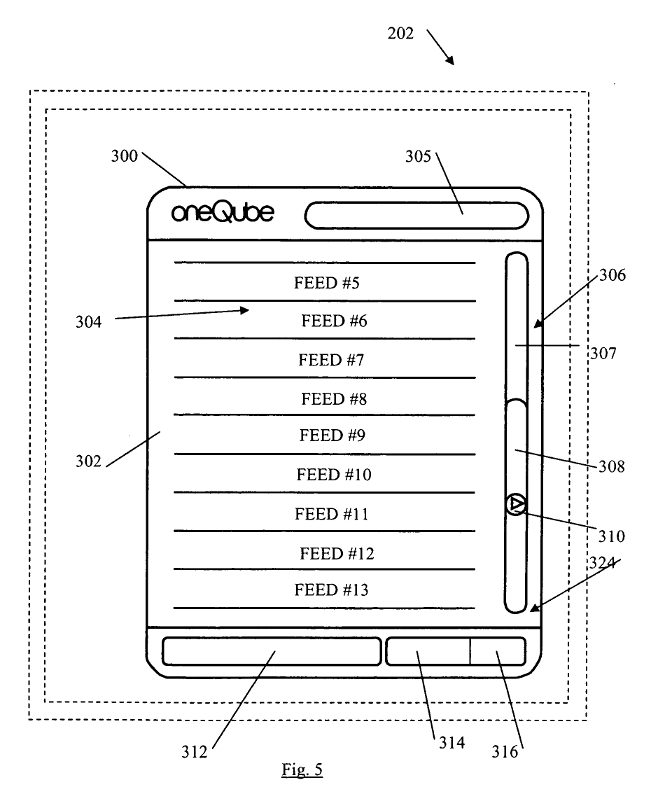

Referring again to FIG. 4, the presentation 300 can also contain a refresh selection/button 316 for requesting a synchronous update of the updated contents 22 from the framework 14. Further, the presentation 300 can also have a scroll mechanism 306 for facilitating manual and/or automated navigation of the portions 304, when there are more portions 304 for display that there is space available in the content area 302. The scroll mechanism 306 contains a scroll region 307, a scroll section 308 that is smaller in dimension than the scroll region 307, and an activation selection/button 310 for activating/halting the scrolling of the portions 304 in the content area 302. For example, the scroll section 308 can move in a reciprocal manner within the scroll region 307 as all of the portions 304 are iteratively displayed in the content area. For example, FIG. 4 shows the scroll section 308 located at the top or one end 322 of the scroll region 307, thus providing for a display of the portions 304 related to the first nine feeds (e.g. FEED #1, FEED #2 . . . FEED #9) out of thirteen feeds chosen in the content selections 320 of the user 16. Referring to FIG. 5, shown is the presentation 300 having the last nine feeds (e.g. FEED #5, FEED #2 . . . FEED #13) out of the thirteen feeds, with the scroll section 308 located at the bottom or the other end 324 of the scroll region 307. It is recognised as the scroll section 308 reciprocates or is otherwise manually positioned within the scroll region 307, a corresponding subset of the total portions 304 available is displayed in the content areas 302 (e.g. FEED #3 to FEED #12 are shown when the scroll section 308 is located approximately in the centre of the scroll region 307). In this manner, the user 16 can interact with all of the portions 304 displayed in the content area 302, in an iterative fashion. The button 310 can be used to manually position the scroll section 308 within the scroll region 307 and/or to select the automated reciprocal scrolling of the scroll section 308, as described by example.

The reader also has a search query feature 305 (e.g. a text search box) that can be used by the user 16 to search for specified keywords/word groups (e.g. search phrases) in the updated content 22 present in the presentation 300. For example, if general World News related updated content 22 was being presented in the presentation 300, the user could identify portions 100 related to a certain country (e.g. France) and then search for all current updated content 22 that is related to France (or otherwise contains the keyword France in the content). The results of the query 35, for say France, would then be presented in the presentation 300 as a plurality of corresponding predefined portions 304 each populated with one (or more) of the matching portions 100, for example.

### Reader Framework 330

Referring to FIG. 6, shown is an example reader framework 330 for the reader 18. The reader framework 330 is responsible for interacting with the aggregation framework 14 to coordinate selection of the content selections 320 (including individual category selections 312) by the user 16 and to register those content selections 320 with the aggregation framework 14. Based on the content selections 320, the reader framework 330 coordinates communication with the aggregation framework 14 over the network 11 to receive and subsequently present the updated content 22 in the presentation 300 on the user interface 202 (see FIG. 6).

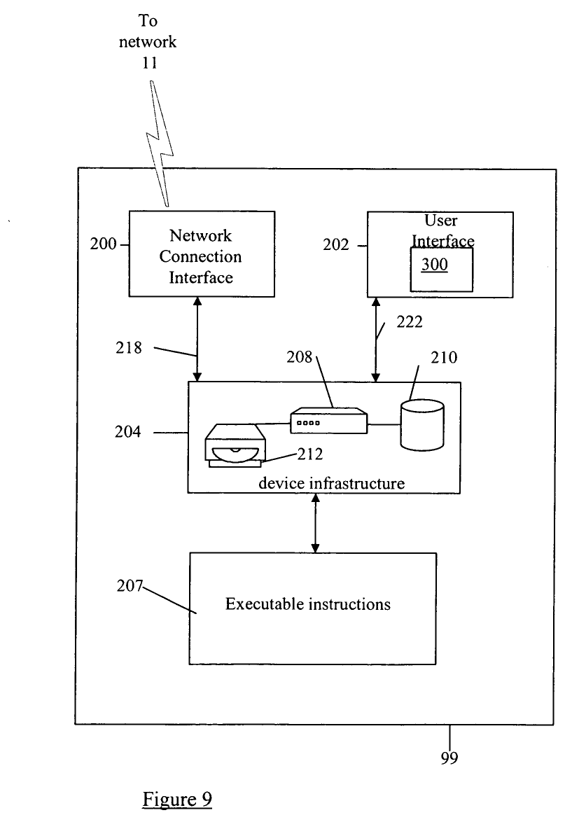

The reader framework 330 has an interface module 334 for communicating with the user interface 202 of the user's device 99 (see FIG. 9), so as to obtain content selections 320 from the user 16 and to receive configuration data 340 that specifies the manner of operation of the reader 18 as desired by the user 16 (e.g. maximum number of contents 20 in the updated contents 22, maximum number of portions 100 for use in the presentation 300, speed/frequency of scrolling, number of individual predefined portions 304 (see FIG. 4) to display, size and location of the presentation 300 on the user interface 202, look and feel of the presentation 300 (e.g. colour scheme, etc.), and/or desired/preferred sources 12 for obtaining the contents 20. It is recognised that the predefined portions 304 could be configured to be populated with a subset of the total available portions 100 of the individual contents 20 (e.g. the title 102, the short description 106 or the full description 106, only the name/channel 101 of the source 12, or a combination of any of these portions 100), such that the portions 100 used to populate the predefined portions 304 would change depending upon user 16 interaction. For example, the user clicking on a displayed title 102 in one of the predefined portions 304 would cause the title 102 to be replaced by the corresponding description 106, for example. In any event, it is recognised that the portions 100 used to populate the predefined portions 304 is configurable, as implemented by a generation module 336 for example. It is also recognised that certain predefined portions 304 could be configured to present only that content 20 of the updated content 22 that matches a specified content category 130, as desired.

Further, the interface module 338 communicates the configuration data 340 to a configuration module 338, which coordinates with the generation module 336 for rendering (e.g. population of the predefined portions 304) of the presentation 300 (with the received updated contents 22) on the user interface 202. The configuration module 338 can also communicate the configuration data 340 and/or content selections 320 to a communication module 332, which can make this information available to the aggregation framework 14. It is recognised that the configuration data 340 can include a profile 504 of the user 16, including pubic tags 405 assigned to/by the user 16 (see FIG. 7). The communication module 332 is also responsible for obtaining the updated content 22 from the aggregation framework 14 and for making this updated content 22 available to the generation module 336 for subsequent generation of the presentation 300, based on any available configuration data 340.

Further to the above, it is recognised that the configuration data 340 (supplied by the user and/or the aggregation framework 14) can also be used to filter the contents of the updated contents 22. For example, the updated contents 22 could contain more information that is configured to be displayed/presented in the presentation 300 at any one time, such that the configuration data 340 is used by the generation module 336 to select which portions 100 to use for population of the predefined portions 304 as which of the portions 100 goes in which of the predefined portions 304 (e.g. if some or all of the predefined portions 304 are configured for specific categories 130). Further, it is recognised that the reader 18 can use the use of categories assigned to the predefined portions 304 to alternately present content of different categories 130 in one or more of the predefined portions 304. For example, the content area 302 could first present contents 20 of one or more categories 103 (included in the updated contents 22) and then the content area 302 could secondly present contents 20 of categories different from the first one or more categories 103. In this manner, the contents presented in the presentation 300 could be updated without the need of further updated content 22 material supplied by the aggregation framework 14, until the next scheduled change in the updated contents 22 occurs.

### Profiles 503, 504

Referring to FIG. 7, each of the content 20 and the various users 16 can have a defined profile 503 and a defined profile 504, respectively. These profiles 503,504 can be used to help the framework 14 (see FIG. 1) to appropriately match the various users 16 and the available categorized content 20 to one another, in view of the user's content selections 320 (see FIG. 6) and optionally their profile 504. Accordingly, the definitions (e.g. tags 405) contained in the profiles 503,504 can be used by the framework 14, in combination with the content selections 320 to determine from the available categorized content 20 (from known/specified sources 12) what the updated content 22 will have for use in the presentation 300. For example, each of the available content 20 has been categorized (e.g. by the aggregation framework 14 according to a predefined list of categories 130—which are included in the profile 503 of the individual contents 20).

In any event, it is recognised that the aggregation framework 14 can choose to match the individual contents 20 to the users 16 by: comparing the user's content selections 320 to the categories 130 of the categorized contents 20; comparing the user's content selections 320 and any tags 405 in the user's profile 504 to the categories 130 of the categorized contents 20; comparing tags 405 in the user's profile 504 to the categories 130 of the categorized contents 20, i.e. ignoring or otherwise discounting the user's content selections 320 in the comparison; and/or comparing the user's information (e.g. tags 405 and/or content selections 320) to both the categories 130 of the categorized contents 20 as well as to the tags 405 in the profiles 503 of the categorized contents 20.

It is recognised that the profiles 503,504 include the tags 405, which can also be combined with category selections 312 of the content selections 320 to determine the best match(es) from a group 401 of available categorized contents 20 of the aggregation framework 14. These matched categorized contents 20 are then included in the updated contents 22 for communication to the reader 18 (of the user 16) and subsequent presentation in the presentation 300. It is recognised that the tags 405 can include public tags 406 and/or private tags 408, as further described below, which can be defined as a tag cloud 502.

### Tags 405

Referring again to FIGS. 6 and 7, the tags 405 are single/multiple alpha and/or numeric descriptors (e.g. words) used to categorize or otherwise label content of the presentation 300 (e.g. portions 304) so that the framework 14 (see FIG. 1) can match user's 16 with corresponding categorized contents 20 (e.g. a list 501 of categorized contents 20 stored in a storage 210 of the aggregation framework 14—see FIG. 8). The tags 405 can be (relevant) keyword(s) or term(s) or phrases associated with or otherwise assigned to the contents 20 and users 16, thus describing/defining the contents 20 and users 16 and assisting in a descriptive/keyword-based matching of the contents 20 and users 16. The tags 405 can be metadata involving the association of descriptors with objects and can be embodied as the syntax (e.g. an HTML tag/delimiter such as a coding statement) used to delimit the start and end of an element, the contents of the element, or a combination thereof.

Referring again to FIG. 7, each the contents 20 and users 16 has associated with it one or more of the tags 405, as part of a predefined classification system/process. Each of the contents 20 and users 16 can have the respective profile 503, 504 including an identifier 402 (e.g. name, URL, address, and other communication/contact information), a corresponding type 404 (e.g. membership status in the framework 14) or assigned category 130, and/or an associated tag 405 cloud. It is recognised that the identifier 402 and the type 404 (or category 130) could be separate from and/or included as tags 405 in the tag cloud. The tag 405 cloud can include public tags 406 and optional private tags 408. The framework 14 can access the tags 405 of the contents 20 and users 16 (e.g. through the respective profile 503,504) in order to link/match those contents 20 and users 16 t one another that contain similar tags 405 (or even to specified collections of tags 405) and/or to match the contents 20 and users 16 to one another according to matching of the content selections 320 of the users with the category definitions 130 of the individual content 20.

The tags 405 can be defined using a structured definition language such as but not limited to the Standard Generalized Markup Language (SGML), which defines rules for how a document can be described in terms of its logical structure (headings, paragraphs or idea units, and so forth). SGML is often referred to as a meta-language because SGML provides a “language for how to describe a language.” A specific use of SGML is called a document type definition (DTD), which defines exactly what the allowable language is. For example, Hypertext Markup Language (HTML) is an example of a structured definition language for defining the tags 405. A further example of the structured definition language is Extensible Markup Language (XML), which defines how to describe a collection of data. Accordingly, the tags 405 can be used to provide an underlying definition/description of the contents 20 and users 16. For example, HTML delimiters can be used to enclose descriptive language (e.g. tags 405) about an HTML page, placed near the top of the HTML in a Web page as part of the heading.

There can be several kinds of tag 405 types useful for matching the contents 20 and the users 16, tags 405 such as but not limited to a keywords meta tag 405 and a description meta tag 405. The keywords meta tag 405 can be used to list the words or phrases that best describe the contents/attributes of the contents 20 and the users 16. The description meta tag 405 can be used to include a brief one- or two-sentence description of the contents 20 and the users 16. It is recognised that both the keywords and the description, of the tags 405, are used by the framework 14 to identify related contents 20 and the users 16 appropriate to the content selections 320 context.

### Tag 405 Examples

The following are example of tags 405 that can be used to match contents 20 from the list 501 with the users 16.

```
<META name=“resource-type” content=“document”>
    the resource type tag 405 can include types such as but not limited
    to document, video, people, image, audio, blogs, etc.
<META name=“description” content=“a description of the contents 20 and
the users 16 ”>
    the description type tag can be displayed along with the title of the
    contents 20 and the users 16 in an index. “content” could be a
    word, sentence or even paragraph to describe the contents 20 and
    the users 16.
<META name=“keywords” content=“a, list, of, keywords”>
    the keywords type tag 405 can include one or more descriptive
    keywords, separated by commas. The keywords can include
    synonyms, colloquialisms, and so on. For example, if the contents
    20 and the users 16 are related to cars, the keyword tags 405 can
    include “car”, “cars”, “vehicles”, “automobiles”, autos, etc.
<META name=“distribution” content=“one of several”>
    the distribution type tag 405 can be used to list available resources
    to find things, such that the content should contain either global,
    local or IU (Internal Use).
```

Other examples of tags 405 include: a specific XML definition, such as Microsoft's Channel Definition Format (CDF), which defines a set of tags 405 for describing a Web channel; and an ID3 tag as a type of meta data container used to store information about an MP3 file (e.g. such as a podcast) within the audio file itself. The ID3 tag 405 allows the creator of a file to embed relevant information (including hyperlinks and images) like the name of the artist, track title, album, track number and genre in the file, allowing that information to travel with the file. It is also recognised that the metadata can be defined as a set/list of descriptors (words, phrases, etc.) that are indexed or otherwise associated with the individual entities to comprise individual tags 405 or group tags 405, e.g. each word/phase is classified as a separate tag 405 and/or a group of words/phrases is classified as a single tag 405.

### Public 406 and Private 408 Tags

The framework 14 can administer the association of the tags 405 to respective contents 20 and the users 16. It is recognised that either or both of the framework 14 and the user 16 (and the content sources 20) can assign the public tags 406 to the users 16 (and the respective content 20). For example, a blog containing articles on luxury automobiles could contain public tags 406 including descriptions of well-known luxury cars, keywords related to luxury car brands, etc, as provided to the framework 14 by the content source 12 of the blog (i.e. both the source 12 and the framework 14 share knowledge of the supplied public tags 406 for the respective contents 20). Another example is where the user 16 would supply the profile 504 description of themselves containing the public tags 406, e.g. user name, user age, user occupation, user geographic location, interests, etc. It is recognised the public tags 406 may or may not be shared with other sources 12/users 16 not associated with the specific user 16, as desired. For example, user “A” may supply public tags 406 to the framework 14 for inclusion in their respective profile 504 (i.e. thereby setting up shared knowledge of the supplied public tags 406 between the framework 14 and the user A for it's profile 504). However, the framework 14 could restrict access to these public tags 406 by other users 16 (and/or sources 12) not related to user “A”.

On the other hand, the private tags 408 are assigned to the contents 20 and the users 16 by the framework 14 and are not made available/shared outside the framework 14. For example, the framework 14 restricts knowledge/access of the user 16 (or source 12) for private tags 408 contained in the profile 504 of user 16, as well as restricts knowledge/access of the user 16 (or the source 12) for private tags 408 contained in the description/definition profile 503 of contents 20. The private tags 408 are assigned to the contents 20 and the users 16 by the framework 14 to help provide better context/sourcing for matching contents 20 and the users 16 to one another. It is recognised that the assignment of private tags 408 by the framework 14 to respective contents 20 and the users 16 can be done on a dynamic basis, e.g. for example for a specified update period such as a 90 day window. The dynamic update of the private tags 408 can be the result of behavioural analysis of the contents 20 and the users 16 for the specified update period. It is also recognised that the private tags 408 could be used as part of the categories 130 assigned to respective contents 20 in the list 501 (see FIG. 8).

One example of private tags 408 are keywords that are representative of the character traits (e.g. behavioural information 414) of users 16 currently accessing certain contents 20, which demonstrates monitoring of behavioural patterns with respect to the certain contents 20. For example, the framework 14 could note that a specific technology related news content 20 is accessed predominantly by individual users 16 that are known to be high wage earners and male. Accordingly, the keyword tags of “high wage” and “male” as behavioural information would be added by the framework 14 to the private tags 408 of the news content 20. In the future, if tracking of access to the specific news content 20 (by the framework 14) notes that high wage males and females are predominant, then the framework 14 would change the keyword tags 408 of the news content 20 to include “high wage”, “male”, and “female” private tags 408. These private tags 408 would not be accessible by the source 12 of the specific news content 20 nor by the individual users 16 accessing the specific news content 20. One reason for limiting knowledge of the keywords used as private tags 408 is that: the source 12 of the specific news content 20 may not appreciate or otherwise agree with the association of tags 408 for “high wage”, “male”, and “female” with their content 20; and/or the individual users 16 may not appreciate or otherwise agree with the explicit labelling of “high wage”, “male”, and “female” included in their profiles 504.

A further example of selecting private tags 408 to associate with a content 20 and users 16 is using behavioural analysis of a user 16. For example, behavioural information 414 related to the selected user 16 could include information such as but not limited to: history of access to certain content 20 including content category 130 and frequency/timing of access; history of access to new content 20 not from the usual certain content 20; identification details of a browser 207 and/or of device 99 of the user—see Figure **; information on the user and/or user device 99 obtained from a third party information database (not shown)—example air miles or other reward programs; browsing behaviour and/or user profile, shopping profile, or other user profile data not included in the public tags 406; or a combination thereof. It is recognised that browsing behaviour can include behaviour 414 such as but not limited to: user clicks (on-click event) on a link or performs some other user action (e.g. mouse-over/hover event) during interaction with selected content 20 of the presentation 300; type of content 20 interacted with; number of interactions with selected content 20 displayed in the presentation 300; the amount of time spent interacting with particular content 20; etc.

The behavioural information 414 of the user 16 can be monitored by the framework 14, can be supplied to the framework 14 by a third party, or a combination thereof. Again, in the context of user 16 profiling 504, it is recognised that the users 16 may not appreciate the association of certain tags 405 to their description (e.g. user profile 504), hence the usefulness of private tags 408 to embody the known behavioural information 414 of the user 16. Accordingly, access to private tags 408 details, that are part of the tag 405 cloud for a respective user 16 and/or content 20, is restricted by the framework 14 for those individuals/organizations that are external or are otherwise not associated/related to the framework 14.

### Aggregation Framework 14

Referring to FIG. 8, in a scenario of using web feeds (e.g. content 20), the content provider (e.g. source 12) publishes a feed link on their site which end users 16 and/or the source 12 can register with the aggregator framework 14. The framework 14 then makes the content 20 available to feed/news readers (e.g. the reader 18) running on user's 16 machines 99. When instructed or otherwise configured, the aggregator framework 14 asks all the source 12 servers in its content list 501 if the sources 12 have new content 20. If so, the aggregator framework 14 either makes a note of the availability of the new content 20 or downloads it to the storage 210 with the appropriate assignment of categories 130 and/or tags 405. It is recognised that the aggregator framework 14 can be scheduled to check for new content 20 periodically. The framework 14 makes the new content 20 available to the user 16 as updated content 22 that is then interpreted by the user's reader 18 and then presented on the user interface 202 (see FIG. 6) as the presentation 300.

The Framework 14 includes a registration module 508 for receiving the content selections 320 from the user 16 for storing in a member database/list 511, and a distributor module 506 for sending the corresponding updated contents 22 to the user 16. The registration module 508 can also be responsible for generating or otherwise receiving a user profile 504, also for storing in the member database 511, for example. A generator module 510 is used to generate the update contents 22 that correspond to the content selections 320 of each specific user 16 as well as any information used from the user profile 504, as configured. A contents collector module 504 is used to obtain all contents 20 from the content sources 12 for use in preparing the updated contents 22. A categorizer module 502 is used to assign the categories 130 to each of the collected contents 20 from a list 503 of predefined categories. It is recognised that the list 503 can also contain a plurality of predefined tags 405 also for use in assigning to the contents 20 as well as to the users 16 (e.g. via their respective profiles 503,504—see FIG. 7). Further, it is recognised that the distributor module 506 and/or the registration module 508 can provide profile information 507 obtained from the user 16 (and/or from third party sources as well as from determined behavioural information 414 of the user 16) to the categorizer module 502 for use in updating the profiles 503,504, as desired.

In an example operation of the framework 14, the registration module 508 registers a user 16 in the database 511 including content selections 320 and/or profile 504 information. Further, the contents collector module 504 searches through the available contents 20 of the sources 12 (e.g. via the use of bots, etc.) and makes these contents 20 available to the categorizer module 502 for categorization and then storage of at least this categorization (with an identification of the contents 20—e.g. via the appropriate name 102 and/or link 104—see FIG. 2) in the contents list 501. At a determined update time/schedule for the contents 20 of various user presentations 300, the generator module 510 obtains the respective content selections 320 of a specific user and/or the respective profile 504 and then compares this information with assigned categories 130 of the contents 20 in the list 501 and/or the tags 405 of their respective profiles 503, in order to determine the appropriate update contents 22 (e.g. a grouping of the categorized contents 20 that matched). The generator module 510 then makes the update contents 22 available to the distributor module 506 along with the network 11 address of the user's reader 18 (see FIG. 6). The distributor module 506 then communicates the updated contents 22 to the user's reader 18 over the network 11.

The reader framework 330 of the reader 18 then processes the received updated contents 22 and presents them on the user interface 202 (see FIG. 6) as the presentation 300. In interaction with the presentation 300 by the user 16, the registration module 508 would receive subsequent request(s) for additional content (e.g. request for the full story associated with a particular news title initially presented as one of the content portions 304, periodic update of all the content portions 304, search query using feature 305—see FIG. 4, and/or a change in the content selections 320, for example) for the presentation 300. The distributor module 506 would communicate the appropriate updated contents 22 to the reader 18 as generated by the generator module 510 in response to the request(s) for additional content. It is also recognised that the registration module 508 and/or the distributor module 506 could make profile information 507 available to the categorizer module 502 based on details of the request(s) for additional content and/or details of the corresponding updated content 22 (e.g. the user 16 may have added a new content categories 312 to their content selections 320. For example, this profile information 507 may be monitored by the reader 18, in the background during interaction of the user 16 with the presentation 300—e.g. by the interface module 334, and then communicated to the registration module 508 and/or the distributor module 506 unknowingly by the user 16.

### Registration Module 508

The registration module 508 can be part of the network connection interface 200 (see FIG. 9) of the device 99 operating the aggregation framework 14. The module 508 can communicate synchronously or asynchronously with the device 99 of the user 16 over the network 11. In particular, the registration module 508 interacts with the user 16 in order to obtain the content selections 320 and/or profile 504 information of the user 16. It is recognised that once registered with the aggregation framework 14, the user 16 would have a framework 14 identification (for example the network 11 address of the user's device 99) that would be used to associate the subsequently received content selections 320, as well as to correlate the results of those content selections 320 (e.g. the generated updated contents 22) with the appropriate user 16.

It is recognised that providing the registration information of the users 16 and/or sources 12 to the framework 14 can be done over the network 11. The communication of the registration information can include communication modes such as but not limited to: voice communication via phone; written communication via network messaging (e.g. email, facsimile); and/or others as desired. It is recognised that the users 16 and/or the sources 12 registered with the framework 14 could be issued framework ID and password (optional), which uniquely identifies the particular user 16 /source 12. The framework ID could be associated with the tag 405 entries (e.g. profiles 503,504) in the lists 501,511.

### Distributor Module 506

The distributor module 506 can be part of the network connection interface 200 (see FIG. 9) of the device 99 operating the framework 14. The module 506 can also communicate synchronously or asynchronously with the device 99 of the user 16 over the network 11, in accordance with the updated contents 22 as received from the generation module 510.

Further, it is recognised that the distributor module 506 and/or the registration module 508 can provide profile information 507 obtained from the user 16 (and/or from third party sources as well as from determined behavioural information 414 of the user 16) to the categorizer module 502 for use in updating the profiles 503,504. For example, the distributor module 506 could be configured to analyze changes in the data contents of the updated contents 22 over successive updates and to provide the results of that analysis as the profile information 507. For example, the distributor module 506 could note that a specific user 16 only requests changes to the updated contents 22 in certain times/periods of the day, thus facilitating a deduction of the time and frequency of active (vs. passive) connection frequency of the user 16 with the aggregation framework 14. In another example, the distributor module 506 could note that the user 16 is interested in different categories 130 at different times of the day, thus facilitating an anticipation/prediction-of the user's 16 category preferences. It may be that the user's child uses the user's account in the evening while the actual user 16 uses their account only during the day, such that the user and the user's child have distinctly different tastes in the categories 130.

### Generator Module 510

The generator module 510 generates the updated data 22 for use in rendering of the presentation 300, in view of the content selections 320 obtained from the user 16 and/or the user profile 504. It is also recognised that the generator module 510 could also use profiles 503 of the contents 20 to either initially match or to fine tune (e.g. further refine) the initially generated updated contents 22. It is recognised that the content selections 320 can also contain URL/IRL identifications (or other unique identifiers—e.g. name) for specific contents 20 as desired by the user 16. In this case, the generator module 510 may not use categorization/profile matching to select this content 20 from the contents 20 referenced in the content list 501 (see FIG. 8), rather the generator module 510 would use the specific identification for facilitating inclusion of this content 20 in the updated contents 22.

The generator module 510 can use a predefined schedule to periodically make the updated contents 22 available to the user 16, based on the most recent content selections 320 and/or profile 504 available in the database 511. The generator module 510 can also be prompted on demand by the registration module 508 to generate the updated contents 22 based on a received content selection 320 from the user 16.

In particular, the generator module 510 uses the category selections 312 and/or the tags 405 of the profile 504 from the database 511 to match against the categorized content 20 in the content list 501. This comparison could be the category selections 312 and/or tags 405 against the categories 130 in the list 501 and/or could be the category selections 312 and/or tags 405 against the categories 130 and their associated tags in the list 501. In this manner, as a result of the comparison, the generator module 510 obtains a ranking of the categorized contents 20 for a particular user 16. The generator module 510 could use a maximum threshold value to limit the number of content 20 matches that are to be included in the updated contents 22. Further, it is recognised that the category selections 312 and/or tags 405 of the user 16 could be weighted in a specified manner (e.g. tags 405 have less or more weight than category selections 312). Further, it is recognised that the assigned categories 130 and/or tags 405 of the categorized content 20 could be weighted in a specified manner (e.g. tags 405 have less or more weight than category 130).

In the event that the matched content 20 is not available in the storage 210, the generator module 510 could request the collector module 504 to retrieve this content 20 from the sources 12.

### Collector Module 504

The collector module 504 can be thought of as a search engine, for example, which communicates with the plurality of sources 12 in order to obtain contents 20 (or knowledge of the contents 20) that may be made available to one or more users 16 of the aggregation framework 14. The collector module 504 can include a search engine and/or can be linked to a search engine(s) via the network 11.

The collector module 504 can be referred to as a coordinated set of programs that can include: a spider that goes to every page or representative pages of the sources 12 on the network 11 that wants to be searchable and reads it, using hypertext links on each page to discover and read a site's other pages; or a program that creates a huge index (sometimes called a “catalog”) from the pages that have been read. The search can also include an exploration of a structured directory of topics. The search can also be provided as a number of Web portal sites that offer both the collector module 504 and directory approaches to finding information pertaining to contents 20 and/or information for the corresponding profiles 503 (see FIG. 7) of the contents 20.

It is recognised-that specialized content search engines can be utilized by the framework 14, which are selective about what part of the Web is crawled and indexed. It is recognised that the private tags 408 could also be attached to the profile of the specialized search engines based on their speciality. In this case, it is recognised that the search engines could also be included in the database 501 along with their private tags 408, as desired. It is also recognised that the search engines may be configured for Extranet searching (e.g. individual Internet Web sites) as well as for intranet searching (e.g. larger corporate sites).

### Categorizer Module 503

Referring again to FIG. 8, one embodiment of the categorizer module 503 is to request validation of identified contents 20 by the collector module 504, in order to determine if the contents 20 are still available. Further, the categorizer module 503 can determine if the syntax of the contents 20 (e.g. the XML delimiters and associated data) is valid for processing by the reader 18.

The categorizer module 503 is also used to attach additional data to the contents 20, such as but not limited to customized titles, categories 130, descriptions, etc. This additional data is determined based on parsing of the contents 20 to see what information is included in the contents 20. For example, in terms of an RSS feed, the categorizer module 503 could determine the type of items 112 present (e.g. based on a keyword search of the descriptions and/or MXL delimiters) by comparison of the data in the contents 20 to a predefined list of definitions 530. These definitions 530 could be correlated with predefined categories 130 (including sub-categories), predefined titles, predefined descriptions, etc. For example, if the categorizer module 503 determines that there is a frequency of a certain keyword (e.g. car) or group/combination of keywords/phrases in the data of a particular content 20, that matches a predefined category 130, then the categorizer module 503 would assign that category 130 (or more than one category 130 if more than one category 130 is matched) to the content 20 and then list that content 20 and associated category 130 (or categories 130) in the list 501. The categorizer module 503 could also assign categories 130 (from the list of definitions 503) to the content 20 based on the source 12 of the content 20 and/or any tags 405 that are associated with the content 20. It is recognised that the assigned categories 130 to a particular content 20 can change as the tag 405 cloud of the particular content 20 changes. In this manner, the categorization of the content 20 can be done dynamically, or otherwise on a periodic update frequency. Of course, as the data in the content 20 changes over time, the assigned categories 130 to that content could also change in view of the comparison of the data in the contents 20 to the predefined list of definitions 530.

Further, referring again to FIG. 8, the categorizer module 503 is responsible for receiving the profile information 507 and for modifying the tags 405 (e.g. private tags 408) of the user profiles 504 and/or content profiles 503 in the lists 501,511. For example, based on popularity of certain noted content 20, the categorizer module 503 could decide to start monitoring behavioural interaction with the noted content 20 and input corresponding tag 405 entries into the lists 501,511.

Further, it is recognised that the modules 502,504,506,508,510 of the framework 14 and the modules 332,334,336,338 of the reader framework 330 can be configured to operate interactively as shown, the operations/functionality of the 502,504,506,508,510 of the framework 14 and the modules 332,334,336,338 of the reader framework 330 can be combined or the operations/functionality of the selected modules 502,504,506,508,510 of the framework 14 and the modules 332,334,336,338 of the reader framework 330 can be further subdivided, as desired. Further, it is recognised that the modules 502,504,506,508,510 of the framework 14 and the modules 332,334,336,338 of the reader framework 330 can communicate or otherwise obtain their calculated results from one another or can store their respective calculated results in the storage 210 for subsequent retrieval by another module there-from.

Further, it is recognised that the information stored in the storage 210 (e.g. lists 501,511) can be embodied as a (or other structured memory construct). Further, it is recognised that the public tags 406 can provide identification, categorization, descriptive, and/or labelling information (for example) about the respective user 16, contents 20, such that access/knowledge to/of this public information can be made available to both the framework 14 (and members/users 16 thereof) and individuals/organizations outside of the framework 14. For example, the user 16 could supply initial public tags 406 to the framework 14 for use in creating a user profile 504 (see FIG. 7). The user 16 would be allowed to subsequently monitor (add/modify/delete tags 406) or otherwise have knowledge of the contents of the public tags 406 contained in their respective profile 504. The user 16 could expect that the predefined public tags 406 would be actively associated/used with their profile 504 in the processing of the content selections 320, unless otherwise advised (e.g. by the framework 14). Similar access/knowledge to/of this public information is made available to both the framework 14 (including member users 16) and individuals/organizations (e.g. sources 12) outside of the framework 14 for public tags 406 associated with profiles 503,504.

On the other hand, the private tags 408 represent tags 405 to which access/knowledge to/of is restricted in some manner, for those individuals/organisations outside of the framework 14 and to selected member/users 16 inside of the framework. The private tags 408 can also provide identification, categorization, descriptive, and/or labelling information (for example) about the respective user 16 and/or contents 20. It is recognised that the degree of restricted access to the private tag 408 information could be varied: such as but not limited to outright restricted access; full/limited access granted upon request of the user 16/organisation 12 to the framework 14; or a combination thereof. In the below described embodiment(s), access to the private tags 408 to those outside of the framework 14 is described as outright restricted access, by example only.

Communication between the source 12, the framework 14, the user 16 is facilitated via one or more communication networks 11 (such as intranets and/or extranets—e.g. the Internet). The system 10 can include multiple sources 12, multiple users 16, multiple frameworks 14, multiple hosting devices 99, and one or more coupled communication networks 11, as desired.

### Computing Devices 99

Referring to FIGS. 1 and 9, each of the above-described components of the system 10, i.e. the source 12, the framework 14, the user 16 can be implemented on one or more respective computing device(s) 99. The devices 99 in general can include a network connection interface 200, such as a network interface card or a modem, coupled via connection 218 to a device infrastructure 204. The connection interface 200 is connectable during operation of the devices 99 to the network 11 (e.g. an intranet and/or an extranet such as the Internet), which enables the devices 99 to communicate with each other as appropriate. The network 11 can support the communication of the content selections 320 and the corresponding updated contents 22 between the components of the system 10.

Referring again to FIG. 9, the devices 99 can also have a user interface 202, coupled to the device infrastructure 204 by connection 222, to interact with a user (e.g. source 12, user 16, framework 14 administrator, etc.). The user interface 202 is used by the user 16 of the device 99 to view and interact with the presentation 300. The user interface 202 can include one or more user input devices such as but not limited to a QWERTY keyboard, a keypad, a trackwheel, a stylus, a mouse, a microphone and the user output device such as an LCD screen display and/or a speaker. If the screen is touch sensitive, then the display can also be used as the user input device as controlled by the device infrastructure 204. For example, the user interface 202 for the devices 99 used by the users 16 can be configured to interact with a Web browser (e.g. applications 207) to formulate the content selections 320 as well as process the received presentation 300. For the devices 99 used by the framework 14, the user interfaces 202 can be used by a framework 14 administrator to associate (e.g. manually or automated through association software—e.g. applications 207) the tags 405 with the user 16 and/or the content 20, as well as to specify the configuration and operation of the lists 501,511, the definitions 503, and configuration/operation of the modules 502,504,506,508,510.

Referring again to FIG. 9, operation of the devices 99 is facilitated by the device infrastructure 204. The device infrastructure 204 includes one or more computer processors 208 and can include an associated memory 210 (e.g. a random access memory). The computer processor 208 facilitates performance of the device 99 configured for the intended task through operation of the network interface 200, the user interface 202 and other application programs/hardware 207 of the device 99 by executing task related instructions. These task related instructions can be provided by an operating system, and/or software applications 207 located in the memory 210, and/or by operability that is configured into the electronic/digital circuitry of the processor(s) 208 designed to perform the specific task(s). Further, it is recognized that the device infrastructure 204 can include a computer readable storage medium 212 coupled to the processor 208 for providing instructions to the processor 208 and/or to load/update client applications 16. The computer readable medium 212 can include hardware and/or software such as, by way of example only, magnetic disks, magnetic tape, optically readable medium such as CD/DVD ROMS, and memory cards. In each case, the computer readable medium 212 may take the form of a small disk, floppy diskette, cassette, hard disk drive, solid-state memory card, or RAM provided in the memory module 210. It should be noted that the above listed example computer readable mediums 212 can be used either alone or in combination. The device memory 210 and/or computer readable medium 212 can be used to store the profile 504 information of the user 16 of the device 99, such that the profile 504 information is used in processing of the content selections 320 submitted from the device 99 to the network 11. Further, the device memory 210 can also be used by the framework 14 as a means to store and access profile 503,504 information of content 20 and users 16 that are associated/matched with the content selections 320.

Further, it is recognized that the computing devices 99 can include the executable applications 207 comprising code or machine readable instructions for implementing predetermined functions/operations including those of an operating system, a web browser, the reader framework 330, framework 14 for example. The processor 208 as used herein is a configured device and/or set of machine-readable instructions for performing operations as described by example above. As used herein, the processor 208 may comprise any one or combination of, hardware, firmware, and/or software. The processor 208 acts upon information by manipulating, analyzing, modifying, converting or transmitting information for use by an executable procedure or an information device, and/or by routing the information with respect to an output device. The processor 208 may use or comprise the capabilities of a controller or microprocessor, for example. Accordingly, any of the functionality of the frameworks 330, 14 (e.g. modules and subset thereof) may be implemented in hardware, software or a combination of both. Accordingly, the use of a processor 208 as a device and/or as a set of machine-readable instructions is hereafter referred to generically as a processor/module for sake of simplicity. Further, it is recognised that the frameworks 330, 14 can include one or more of the computing devices 99 (comprising hardware and/or software) for implementing the modules, or functionality subset thereof, as desired.

It will be understood that the computing devices 99 of the users 16 may be, for example, personal computers, personal digital assistants, mobile phones, and content players. Server computing devices 99 can be configured for the framework 14, sources 12, as desired. Further, it is recognised that each server computing device 99, although depicted as a single computer system, may be implemented as a network of computer processors, as desired.

We claim:

1. A reader for obtaining a plurality of categorized digital content from a content aggregator framework over a communications network based on a content subscription with the aggregator framework, the reader configured for operation on a digital device, the reader including:
an interface module configured for receiving content category selections from a user of the device and for identifying a profile of the user including one or more user definitions;
a communications module configured for communicating the profile and the content selections to the aggregator framework; and
a generation module configured for presenting updated versions of the digital content to device user when the updated digital content becomes available from the aggregator framework, the digital content being assigned to one or more of the content categories as selected by the user;
wherein the user definitions of the profile and the content selections of the user are used to determine the contents of the updated digital content obtained by the reader.

2. The reader of claim 1 further comprising the generation module configured for selecting predefined portions of the updated digital content and for configuring the content display as the predefined portions in a content area for display by the device.

3. The reader of claim 2 further comprising a scroll mechanism for facilitating the display of a limited number of the predefined portions in a reciprocal manner in the content area.

4. The reader of claim 3, wherein the predefined portions are each assigned at least one of the content categories.

5. The reader of claim 2, wherein the generation module is further configured for providing selectable connections in the predefined portions for facilitating a delivery from the aggregator framework and subsequent display in the content area of related content to the updated digital content.

6. The reader of claim 5 further comprising the interface module configured for facilitating a search query of the user for searching for one or more specified search phrases in the updated digital content.

7. The reader of claim 6, wherein the updated digital content includes different media types and the manner of obtaining the updated digital content from the aggregator framework is selected from the group comprising: continuous; and periodic.

8. The reader of claim 2, wherein the user definitions are tags defined in a structured definition language, the tags selected from the group comprising: numeric; alpha; and alpha-numeric descriptors.

9. The reader of claim 2, wherein the updated digital content also has one or more assigned tags for use in determining said contents of the updated digital content.

10. A method for obtaining a plurality of categorized digital content from a content aggregator framework over a communications network based on a content subscription with the aggregator framework, the method implemented on a digital device, the method including:
receiving content category selections from a user of the device;
identifying a profile of the user including one or more user definitions;
communicating the profile and the content selections to the aggregator framework; and
presenting updated versions of the digital content to device user when the updated digital content becomes available from the aggregator framework, the digital content being assigned to one or more of the content categories as selected by the user;
wherein the user definitions of the profile and the content selections of the user are used to determine the contents of the updated digital content obtained.

11. An aggregator framework for obtaining a plurality of digital content from a plurality of content sources over a communications network and for communicating the digital content to a networked reader based on a content subscription with the aggregator framework, the framework comprising;
a categorizer module configured for assigning at least one content category to each content of the plurality of digital content, the content category selected from a list of predefined categories;
a registration module configured for receiving a content selection from the reader for use in selecting updated digital content from the plurality of digital content based on at least one content category included in the content selection;
a generator module for selecting the updated digital content based on the content selection; and
a distributor module configured for communicating the updated digital content to the reader over the network.

12. The framework of claim 11 further comprising a registration module configured for receiving a profile of the user including one or more user definitions; wherein the user definitions of the profile and the content selections of the user are used to determine the contents of the updated digital content communicated to the reader.

13. The framework of claim 12, wherein the generator module is further configured to select the updated digital content based on the content selection and the user definitions.

14. The framework of claim 13, wherein the user definitions are tags defined in a structured definition language, the tags selected from the group comprising: numeric; alpha; and alpha-numeric descriptors.

15. The framework of claim 14, wherein the updated digital content also has one or more assigned tags for use in determining said contents of the updated digital content.

16. The framework of claim 12, wherein the distributor module is further configured to identify changes in the data contents of the update digital content communicated between the framework and the reader and to modify the update digital content based on these identified changes.

17. The framework of claim 15, wherein the generator module is further configured to use a specified weighting between the tags and the content selection for determining the update digital content.

18. The framework of claim 17, wherein the updated digital content is communicated synchronously or asynchronously.

19. An method for obtaining a plurality of digital content from a plurality of content sources over a communications network and for communicating the digital content to a networked reader based on a content subscription with the aggregator framework, the method comprising;
assigning at least one content category to each content of the plurality of digital content, the content category selected from a list of predefined categories;
receiving a content selection from the reader for use in selecting updated digital content from the plurality of digital content based on at least one content category included in the content selection;
selecting the updated digital content based on the content selection; and
communicating the updated digital content to the reader over the network.
